(19) United States
(12) Patent Application Publication
(10) Pub. No.: US 2011/0215618 A1
(43) Pub. Date: Sep. 8, 2011

(54) Wheelchair seat cushion cover

(76) Inventor: Janice Gail Hopkins, Carrollton, TX (US)

(21) Appl. No.: 12/660,729

(22) Filed: Mar. 3, 2010

(51) Int. Cl. A61G 5/10; A47C 7/62; A47C 7/02; A47C 7/18

(52) U.S. Cl. 297/188.01

(57) ABSTRACT

The invention provides a wheelchair seat cushion cover having a hidden internal pocket. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### FIELD OF INVENTION

The invention is generally related to wheelchairs, and more specifically to wheel chair seat cushion covers.

### PROBLEM STATEMENT

1. Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

2. Discussion

Those who are forced by circumstances to spend time in a wheelchair are often faced with needs above and beyond the obvious lack of ability to ambulate from place to place. For example, one significant challenge to a wheelchair user is the everyday use of a public restroom. A personal challenge could include incontinence or the need to catheterize in order to void. These wheelchair users find it necessary to carry bulky supplies (catheters, wipes, medical gloves, disposable underwear, pads for example) wherever they go in order to deal with whatever individual personal hygiene, incontinence, or medical demands they might be faced with.

Some wheelchairs have a larger pouch or pocket on the backside of the chair to carry needed personal supplies. It is difficult to retrieve these personal supplies once a user enters the handicap restroom stall, which is a problem more amplified when one considers that a great many handicap stalls are not in fact completely accessible and still force the handicapped user to make astonishingly physical efforts to use the restroom.

Typically, personal supplies are carried in a large bag/handbag whenever the wheelchair user travels. Whether going to work, out to dinner with friends, or to a movie, the supplies must be carried along with the user when traveling outside the home. The wheelchair user makes a transfer from the wheelchair to the car seat, which occupies the user's hands and arms; then, the bag of supplies is moved. Arriving at a location, the wheelchair user makes a transfer from the car seat to the wheelchair which occupies the user's hands/arms and the bulky bag is usually transferred to the side of the wheelchair via any means. However, the bag may fall and spill embarrassing supplies, resulting in both uncomfortable embarrassment, as well as the physical difficulty of actually collecting the supplies. Nevertheless, even more issues arise when the user needs to employ the supplies in the bag.

In public, the user wants to discreetly visit restroom facilities. However, because the bag/handbag must be taken into the restroom, the process is much less discrete. Just moving among people and around obstacles, such as chairs, may knock the bag off the wheelchair and expose the contents. Once in a restroom, although there is a wide door for the user to roll through, the handicap stall, the wheelchair must be positioned exactly right for the user to brace, and open the door. Sometimes the bag's straps catch the door handle (sometimes the wheelchair user drops a bag), throwing supplies to the floor, just as the user is maneuvering into the stall. When this happens, the user must retrieve the bag and any spilt items, again causing embarrassment and physical challenges while preventing the bag from closing.

Moreover, sometimes the bag's straps catch the door handle, throwing items to the floor, just as the user is maneuvering into the stall. When this happens, the user must retrieve the bag and any spilt supplies, again causing embarrassment and physical challenges.

Once inside the handicapped restroom stall, the user must transfer to the commode and undress to begin the regime. The wheelchair user must then reach the bag, and in the event supplies did fall out of the bag, hope that they did not accumulate restroom bacteria. If the bag now falls out of reach, the user must redress and transfer to the wheelchair again to retrieve the bag supplies. Accordingly, there exists the need for insuring wheelchair users' private supplies are discreet, easily transportable, and readily available when needed.

### BRIEF DESCRIPTION OF THE DRAWINGS

Various aspects of the invention, as well as an embodiment, are better understood by reference to the following detailed description. To better understand the invention, the detailed description should be read in conjunction with the drawings and tables, in which:

FIG. 1 is an isometric view of the inventive wheelchair seat cushion cover.

FIG. 2 is an exploded view of the cushion cover of FIG. 1.

FIG. 3 is a second isometric view of the inventive wheelchair seat cushion cover with the zipper opened to expose the internal pocket.

FIG. 4 illustrates a wheelchair according to the teachings of the invention.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of supplies) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for —functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

### DESCRIPTION OF THE DRAWINGS

### Overview

The invention provides a wheelchair cushion cover with a built in discreet/hidden pocket for a safer, easier, and more sanitary bathroom experience for the wheelchair bound user. The invention allows the users to forego a large bag—he or she can carry sanitary supplies in the hidden cushion cover pocket, and carry a normal sized bag to contain personal items such as wallets and keys. The personal hygiene and medical supplies for incontinence can be stored in the hidden pocket secured by a zipper or other closing system. Of course, the pocket can store other supplies, such as a handicapped PlaceCard. Situated therein, the supplies are not transferred or conspicuous when getting into or out of transportation. The supplies simply cannot catch on door bathroom stall handles. In use, when the wheelchair user transfers to a commode, the wheelchair seat is in front of the user. Accordingly, the user can easily pick up the seat cushion cover and access the hidden pocket by unzipping a zipper maintained on the back of the wheelchair cushion cover. When finished, the unused supplies are returned to the pocket, and the hidden pocket is zipped closed, the cushion is returned to the wheelchair seat, and the user can transfer back to the wheelchair, knowing the supplies are discreetly out of sight.

### DESCRIPTION OF THE FIGURES

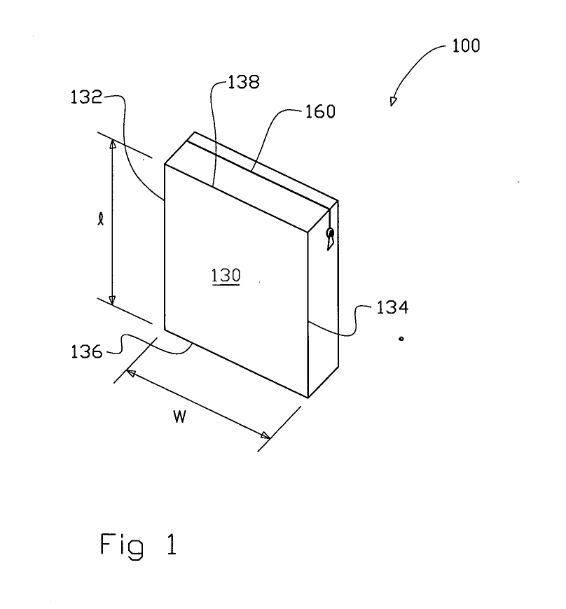

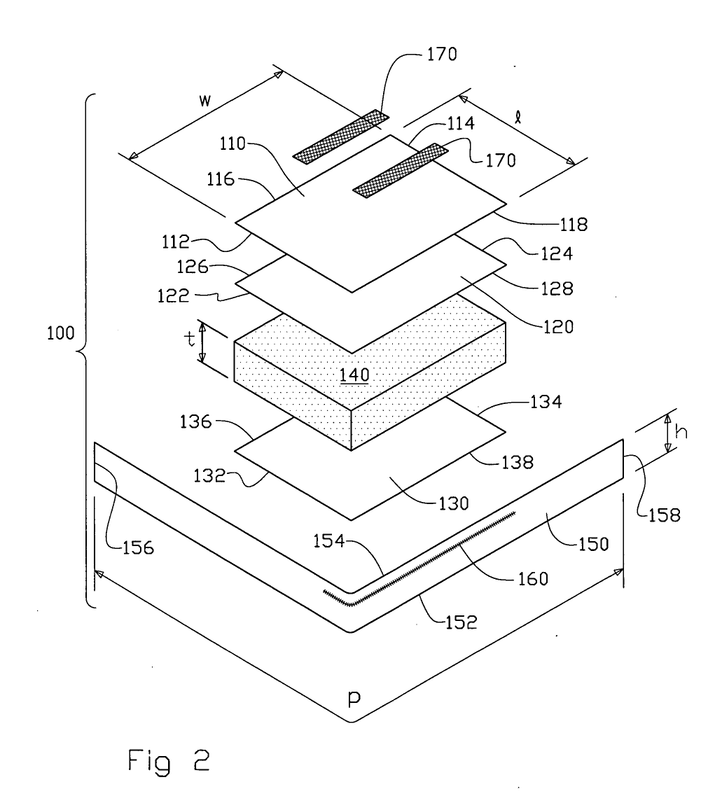

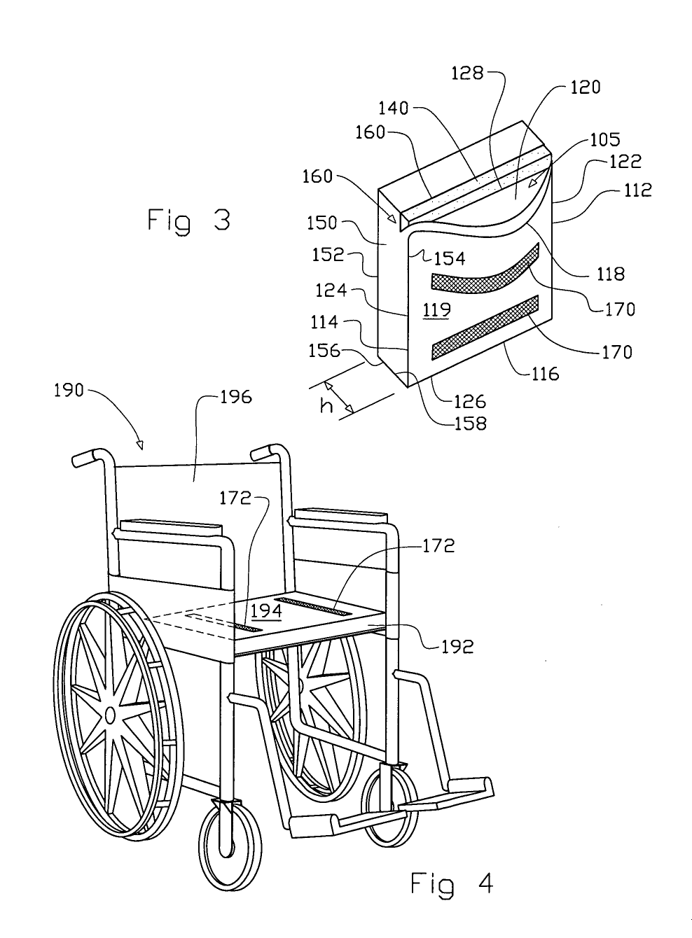

In simultaneous reference to FIGS. 1 through 3, in which FIG. 1 is an isometric view of the inventive wheelchair seat cushion cover a top-down diagram of a wheelchair seat cushion cover 100 having a discreet/hidden pocket 105 which is visible in FIG. 3 which is an isometric view of the inventive wheelchair seat cushion cover opened up to expose the pocket 105. FIG. 2 is an exploded view of the cushion cover 100. From FIG. 2 one can see a first layer 110, second layer 120, and third layer 130 of any selected wheelchair seat cushion cover material, as well as a wheelchair seat cushion 140. A wide variety of material choices are appropriate for the layers 110, 120, 130. For example, the layers 110, 120, 130 may be rayon, nylon, polyester, nylon/Lycra blend, cotton, or leather, for example, or any other any now known or developed material for wheelchair cushion cover use. The cushion 140 is preferably a standard wheelchair seat cushion material such as foam or flexible matrix, viscoelastic foam or matrix, non-deforming foam or matrix, bonded foam, viscoelastic fluid, air cushion, water cushion, gel or solid elastomer, and may be segmented, convoluted, contoured, or cut-out, for example. The cushion 140 has a thickness “t”, which depends on the particular cushion chosen.

The first layer 110, second layer 120, and third layer 130 of the wheelchair seat cushion cover 100 each have corresponding first length edge 112, 122, 132, a second length edge 114, 124, 134, and corresponding first width edge 116, 126, 136, and a second width edge 118, 128, 138. A perimeter 150 of wheelchair seat cushion material has a length “p” being the sum of the four edges of the first layer of wheelchair seat cushion material, or slightly larger, and also having a height “h” equal to or slightly larger than the thickness of the seat cushion 140. The perimeter 150 has a first length edge 152, a second length edge 154, a first height edge 156, and a second height edge 158. The first layer 110 of wheelchair seat cushion material is coupled to the second layer 120 of seat cushion material along the first length edges 112, 122, second length edges 114, 124, and first width edges 116, 126.

The first length edge 152 of the perimeter 150 is coupled to the first layer 110 of wheelchair seat cushion material along the first length edge 112, second length edge 114, first width edge 116, and second width edge 118. The second length edge 154 of the perimeter 150 is coupled to the third layer 130 of wheelchair seat cushion material along the first length edge 132, second length edge 134, first width edge 136, and second width edge 138 of the third layer 130. The perimeter 150 has a horizontal opening 160 along the perimeter, the opening proximate to the second width edge 128 of the second layer 120 of wheelchair cushion material, and may extend to include a portion of either side proximate to the first length edge 122 and/or second length edge 124 of the second layer 120. The horizontal opening 160 is closable via a temporary closing device such as a zipper, buttons, snaps, or loop and hook material, for example, and is shown in the figures as a zipper. As shown, the cushion 140 is removably disposed between the second layer 120 and the third layer 130 within the cushion cover 100, and is accessible via the horizontal opening 160. The horizontal opening 160 also provides access to the pocket created by the cavity between the first layer 110 and the second layer 120.

FIG. 4 illustrates a wheelchair according to the teachings of the invention, where the cushion cover 100 is securely coupled to a wheelchair seat 190. The first layer 110 has an exterior surface 119, and the exterior surface 119 preferably has a loop and hook fastener materials) 170 thereupon, such as Velcro™ thereupon. A wheelchair seat bottom portion 192 has a top surface 194. The top surface 194 has a second loop and hook material (2) 172 thereupon, the second loop and hook material 172 being opposite the first loop and hook material. By “opposite,” it will be understood by those of ordinary skill in the art that loop and hook systems typically have one “loop” surface and one “hook” surface, and that the choice of which material is either a “loop” or a “hook” is largely arbitrary.

The cushion cover 100 is disposed upon the top surface 194 of the wheelchair seat bottom 192 such that the first loop and hook material 170 and second loop and hook material 172 couple the wheelchair seat cushion cover 100 to the wheelchair seat bottom 192. It will be appreciated that although “strips” of loop and hook material are shown in the drawings, that the invention is not so limited in that the loop and hook material may be integral with the first layer and/or seat bottom, and/or may comprise multiple strips. Further, the loop and hook material is not necessarily Velcro™ or a generic alternative, but may be any equivalent means of coupling the cushion cover 100 to the seat 190.

Of course, additional layers of material may be disposed between the first layer 110 and the third layer 130 to create additional pockets. Also, it will be appreciated by those of skill in the art that the horizontal opening 160 is preferably positioned adjacent to the back portion 196 of the wheel chair seat 190. Within the pockets, a user can store supplies such as catheters, medical gloves, disposable underwear, wipes, and/or a handicapped PlaceCard for example.

Accordingly, it will be readily understood by those of ordinary skill in the art upon reading this disclosure that the wheelchair seat cushion cover system addresses the problem of wheelchair-bound persons being unable to discreetly carry personal care supplies and have those supplies easily at hand when they need them. The pocket created is discreet, and the cushion can be sized to accommodate any sized wheelchair.

Furthermore, though the invention has been described with respect to a specific preferred embodiment, many advantages, variations and modifications will become apparent to those skilled in the art upon reading the present application. It is therefore the intention that the appended claims and their equivalents be interpreted as broadly as possible in view of the prior art to include all such variations and modifications.

What is claimed is:

1. An apparatus, comprising:
a wheelchair seat having a bottom portion and a back portion;
a wheelchair seat cushion having a length, a width, and a height;
a wheelchair cushion cover, the cushion cover comprising
a first layer of wheelchair seat cushion material, a second layer of wheelchair seat cushion material, and a third layer of wheelchair seat cushion material, the first, second and third layers of wheelchair seat cushion material being rectangular in shape, and substantially similar in a width dimension as well as a length dimension,
the first, second, and third layers of wheelchair seat cushion material each having corresponding first length edge and second length edge, and corresponding first width edge and a second width edge,
a perimeter of wheelchair seat cushion material having a length being the sum of the four edges of the first layer of wheelchair seat cushion material, and also having a height equal to the height of the seat cushion,
the perimeter having a first length edge, a second length edge, a first height edge, and a second height edge,
the first layer of wheelchair seat cushion material coupled to the second layer of seat cushion material along the first length edges, second length edges, and first width edges,
the first length edge of the perimeter coupled to the first layer of wheelchair seat cushion material along the first length edge, second length edge, first width edge, and second width edge of the first layer,
the second length edge of the perimeter coupled to the third layer of wheelchair seat cushion material along the first length edge, second length edge, first width edge, and second width edge of the third layer,
the perimeter material having a horizontal opening along the perimeter, the opening proximate to the second width edge of the second layer of wheelchair cushion material, the horizontal opening closable via a temporary closing device;
the wheelchair seat cushion disposed between the second and third layers of wheelchair seat cushion material;
such that the space between the first layer of wheelchair cushion cover material and the second layer of wheelchair cushion cover material define a hidden pocket;
the first layer comprising an exterior, the exterior having a first loop and hook fastener material thereupon;
the wheelchair seat bottom portion having a top surface, the top surface having a second loop and hook material thereupon, the second loop and hook material being opposite the first loop and hook material;
the cushion cover disposed upon the top surface of the wheelchair seat bottom such that the first loop and hook material and second loop and hook material couple the wheelchair seat cushion to the wheelchair seat.

2. The apparatus of claim 1 wherein the cushion cover material comprises one of the following: Lycra, polyester, cotton, synthetic sheepskin, or nylon.

3. The apparatus of claim 1 wherein the temporary closing device is a zipper.

4. The apparatus of claim 1 wherein the temporary closing device is a loop and hook material.

5. The system of claim 1 further comprising a fourth layer of wheelchair seat cushion material coupled to the second layer of seat cushion material along the first length edges, second length edges, and first width edges.
